(19) United States
(12) Patent Application Publication
(10) Pub. No.: US 2009/0172753 A1
(43) Pub. Date: Jul. 2, 2009

(54) Method and Apparatus to Facilitate Providing On-Demand Access to Internet Media Content with Other Televised Content

(75) Inventors: Brett Lindsley, Wheaton, IL (US); Matt Defano, Chicago, IL (US); Jianjun Fang, Long Grove, IL (US); Bhavan Gandhi, Vernon Hills, IL (US); Alfonso Martinez Smith, Algonquin, IL (US); Robert G. Scheffler, Peyton, CO (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,062

(22) Filed: Dec. 27, 2007

(51) Int. Cl. H04N 7/173

(52) U.S. Cl. 725/91; 725/87

(57) ABSTRACT

An audio-visual content service provider (200) processor (201) receives (102) an end user (203) selection of at least one particular Internet media content channel via an audio-visual content service provider-end user interface. The audio-visual content service provider then provides (103) on-demand access to this at least one particular Internet media content channel to this end user as a selectable viewing channel along with other televised audio-visual content channels. By one approach, the audio-visual content service provider can receive the described end user selection via a browser-based interface.

### RELATED APPLICATION(S)

This application is related to co-pending and co-owned attorney's docket number CML06333 (7303/91203), entitled METHOD AND APPARATUS FOR METADATA-BASED CONDITIONED USE OF AUDIO-VISUAL CONTENT and filed on even date herewith, which is incorporated by reference in its entirety herein.

This application is related to co-pending and co-owned attorney's docket number CML06334 (7303/91204), entitled METHOD AND APPARATUS TO FACILITATE THE LOCAL RECORDING OF AUDIO-VISUAL CONTENT FOR SUBSEQUENT RE-BROADCASTING IN THE ABSENCE OF END USER REQUESTS and filed on even date herewith, which is incorporated by reference in its entirety herein.

This application is related to co-pending and co-owned attorney's docket number CML06336 (7303/91206), entitled METHOD AND APPARATUS FOR PROVIDING A DYNAMIC PROGRAMMING GUIDE CONTAINING FUTURE TIMES WHEN ON-DEMAND BROADCASTING REQUESTS CAN BE SATISFIED and filed on even date herewith, which is incorporated by reference in its entirety herein.

### TECHNICAL FIELD

This invention relates generally to audio-visual content-based services and more particularly to the provision of audio-visual content to service provider end users.

### BACKGROUND

Audio-visual materials of various kinds are well known in the art as are various ways of conveying such content to an end user to facilitate the consumption of the former by the latter. In many cases, an audio-visual content service provider obtains such audio-visual content from one or more content providers and arranges for the distribution of that content to one or more end users. In the case of televised audio-visual content, such an audio-visual content service provider often comprises, for example, a Community Access Television (CATV) service provider, an Internet Provider Television (IPTV) service provider, a mobile device service provider (such as a cellular telephony service provider), or the like.

In a typical application setting, the audio-visual content service provider provides such audio-visual content to its end users via any of a plurality of selectable channels. In some cases a given channel will carry a previously scheduled multipoint broadcast that is simultaneously receivable by all subscribing end users. In other cases, some channels will carry so-called video on demand (VOD) content intended for only a specific requesting end user. In either case, the content is ordinarily provided by any of a number of audio-visual content sources using (in many cases) dedicated carriers/networks to convey such content to the audio-visual content service provider.

Though a successful paradigm, such that a large percentage of the viewing public subscribes to one or more such audio-visual content service providers, existing platforms and technologies do not necessarily address all potential end user interests. The Internet, for example, is home to a wide variety of potentially interesting media content including audio-only content, video-only content, audio-video content, text-based content, still images, web pages, and so forth. Existing solutions in this regard, however, are poorly suited to provide end user access to Internet media content sources.

### BRIEF DESCRIPTION OF THE DRAWINGS

The above needs are at least partially met through provision of the method and apparatus to facilitate providing on-demand access to Internet media content with other televised content described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an audio-visual content service provider processor receives an end user selection of at least one particular Internet media content channel via an audio-visual content service provider-end user interface. The audio-visual content service provider then provides on-demand access to this at least one particular Internet media content channel to this end user as a selectable viewing channel along with other televised audio-visual content channels. By one approach, the audio-visual content service provider can receive the described end user selection via a browser-based interface.

These teachings will readily accommodate pre-registering Internet media content sources to serve in this regard with the audio-visual content service provider processor. By this approach, the candidate Internet media content channels presented to a given end user can be limited to Internet media content sources that have already been registered with the audio-visual content service provider and which have therefore presumably satisfied whatever standards may be imposed to qualify in this regard.

By one approach, selected Internet media content can be locally stored by the audio-visual content service provider processor to thereby provide that stored content in readiness for being recalled and provided to a given end user via the referred to on-demand service. These teachings will also accommodate combining such Internet-based media content with supplemental content of choice when providing this on-demand access via the audio-visual content service provider's channels.

So configured, those skilled in the art will recognize and appreciate that these teachings provide a flexible and highly scalable mechanism for permitting a wide variety of Internet-based media content to be offered by an audio-visual content service provider processor to end users via a corresponding channel-based video on-demand process. In particular, these teachings provide an efficient and effective way of permitting Internet media sources to be registered with the audio-visual content service provider and for end users to identify specific Internet-based media content that they wish to receive via an on-demand channel to accompany their other existing channel-based viewing options.

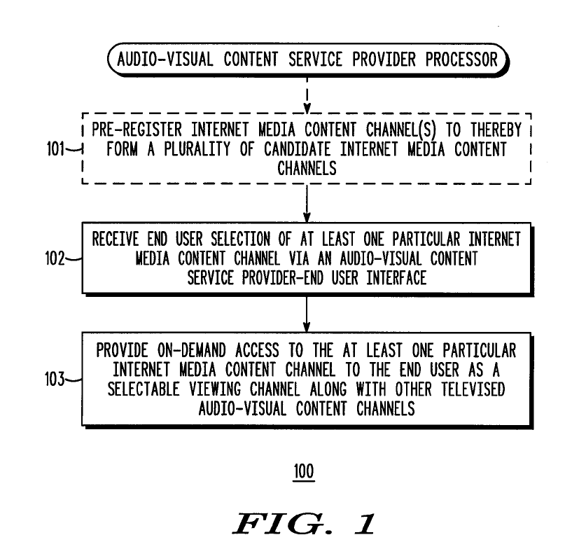

These and other benefits may become clearer upon making a thorough review and study of the following detailed description. Referring now to the drawings, and in particular to FIG. 1, an illustrative process that is compatible with many of these teachings will now be presented.

This process 100 can be carried out at an audio-visual content service provider such as, but not limited to, a Community Access Television (CATV) service provider (which can comprise, for example, a cable-based service provider or a satellite-based service provider), a mobile device service provider such as a cellular telephony service provider, and so forth. More particularly, this process 100 can be effectuated at the head end facilities of the audio-visual content service provider as versus, for example, at the facilities of the content providers or at the facilities of the end users.

As described herein, and for the sake of simplicity, this process 100 will be understood to be carried out by a processor. Those skilled in the art will recognize and appreciate that such a processor can comprise a fixed-purpose hard-wired platform or can comprise a partially or wholly programmable platform. It will also be understood that such a “processor” can comprise a single platform or can comprise a logical architecture wherein the described functionality is distributed over two or more supporting platforms. All of these architectural options are well known and understood in the art and require no further description here.

This process 100 optionally provides for this processor pre-registering 101 one or more Internet media content sources to thereby form at least one (and likely more) candidate Internet media content channels to be offered to the audio-visual content service provider's end users. By one approach this pre-registration process can be enabled using a standard browser-based and/or client-server methodology via, for example, the Internet. Using such an automated interface, those skilled in the art will understand that the Internet media content source can provide information as posed by the audio-visual content service provider in order to complete this pre-registration activity.

The precise information gleaned by the audio-visual content service provider via this approach will of course vary from one audio-visual content service provider and/or application setting to another. Some examples in this regard might include, but are not limited to, source identification information, billing terms, conditions, and information, contact information, quality of service requirements, content restrictions and obligations, encryption requirements, and so forth. Generally speaking, the pre-registration process can serve to permit the audio-visual content service provider to vet the Internet media content source with respect to various criteria of interest and concern and to ensure that the Internet media content source is able to effect at least a minimal level of service with respect to the audio-visual content service provider's requirements.

This pre-registration activity can also provide the vehicle whereby the specific content to be provided by the Internet media content source is specified. The content, of course, can vary widely from source to source. As one example, a content source such as YouTube might make itself available to support, at any given time, a channel that offers the top twenty most popular video clips at YouTube at any given moment. As another example, a content source such as NFL.com might make itself available to support a channel that offers highlights from each National Football League football game during a given period of time of interest.

In any event, this process 100 then provides for the audio-visual content service provider processor receiving 102 an end user selection of at least one particular Internet media content channel (for example, from amongst a plurality of candidate pre-registered Internet media content sources as described above). This can comprise, by one approach, receiving this selection via an audio-visual content service provider-end user interface of choice. The latter might comprise, for example, a browser-based end user interface.

Using that approach, and by way of illustration, the end user can direct their computer's browser of choice (such as Firefox or Explorer) to a website operated by the audio-visual content service provider. This website can be configured and arranged to display the available candidate Internet media content channels for the end user. Such a display can readily comprise, if desired, actual sample content (live or pre-recorded) to illustrate the kind of material that the end user could expect to receive from each such channel. A simple point-and-click approach could be used, if desired, to permit the end user to make their channel selections. The audio-visual content service provider can permit the end user to select any number of candidate Internet media content channels if desired, or can impose such limits as may be appropriate (based upon, for example, subscription terms and expectations as between the audio-visual content service provider and the end user), bandwidth considerations, limitations as may be imposed by the corresponding Internet media content sources themselves, and so forth).

As noted, these Internet media content channels can be as numerous and as varied as desired as these teachings are readily scalable in this regard. By one approach, at least some of the available Internet media content channels can comprise channels that provide access to a particular genre of streaming audio-visual content. Illustrative examples in this regard would include a channel dedicated to a genre comprising most popular video clips, a sports-based genre, a comedy-based genre, a celebrity-based genre, or a news-based genre, to note but a few. Those skilled in the art will recognize that the foregoing examples are intended to serve only in an illustrative capacity and are not intended to comprise an exhaustive presentation in this regard or to otherwise serve as a limitation by example.

Once the end user has made their selection of one or more such Internet media content channels the audio-visual content service provider processor can then provide 103 on-demand access to those selected Internet media content channels to the end user as selectable viewing channels that supplement the other more traditional televised audio-visual content channels as are also provided by the audio-visual content service provider to the end user. As a simple illustrative example in this regard, the audio-visual content service provider could provide a given end user with the ability to select a fishing-based Internet media content stream of content as has been assigned by the audio-visual content service provider to channel number 453 within the audio-visual content service provider's television broadcast system.

By one approach, such channels can comprise a live stream of content from the Internet media content source. By another approach, these channels can comprise content that the audio-visual content service provider has locally recorded and/or otherwise locally stored upon receiving such content from the corresponding Internet media content source. This stored content can then be recalled as necessary to provide the described on-demand access to the end user. As one advantage in this regard, when multiple end users have registered for the same Internet channel the service provider may cache a single copy of the Internet content and then distribute it simultaneously to multiple end users. By one approach, a service provider may decide to cache a small set of content from many of the Internet channels to ensure that the audio-visual content is quickly available upon request by an end user.

There are various ways to accommodate the creation of such channels. By one approach, the processor can simply arrange a direct mapping of each feed to a corresponding channel. It would also be possible to create a channel by applying a filter to corresponding content metadata (such as specific keywords or the like) to yield the content to be channelized. It would also be possible to create a channel by re-organizing the metadata or to prioritize the metadata (using, for example, corresponding input from a social network of choice). Other possibilities also likely exist in this regard or may be developed going forward.

These teachings will also accommodate, if desired, combining media content from the Internet media content source with supplemental content when providing this on-demand access to the Internet media content channel for the end user. Such supplemental content can vary as desired. By one approach, and by way of example and not by way of limitation, this supplemental content can comprise advertising or promotional content. By way of another example, this supplemental content can comprise information regarding other related content that is available to the end user via the audio-visual content service provider that the end user may be interested in viewing.

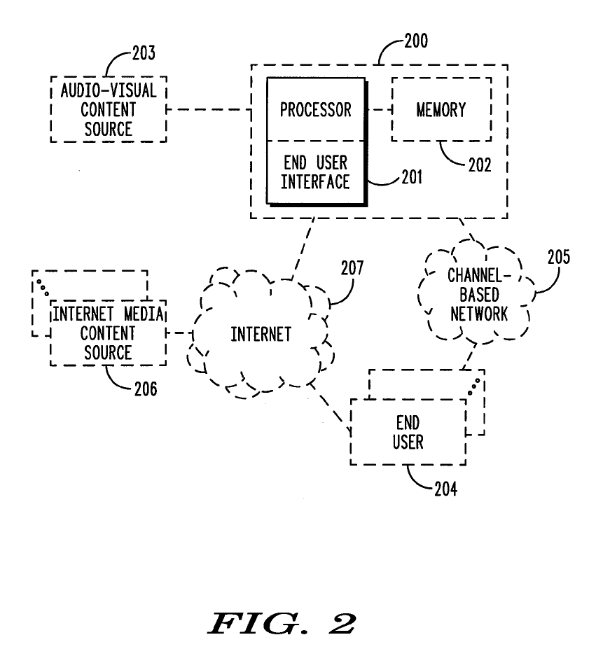

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, an audio-visual content service provider 200 comprises, in part, a processor 201 that can operably couple to a memory 202 as desired. Such a memory can serve, for example, to store audio-visual content from one or more Internet media content sources that has been recorded by the audio-visual content service provider pursuant to these teachings. These audio-visual content service provider facilities 200 can operably couple to one or more audio-visual content publishers 203 that source traditional audio-visual content such as movies, sporting events, episodes of various television programs, and so forth. The audio-visual content service provider's facilities 200 then further operably couple to one or more end users 204 (such as a plurality of residential facilities such as homes, condominiums, apartments, and so forth) via one or more intervening networks 205. By one approach, this network 205 can comprise a cable-based or a satellite-based television broadcasting distribution system as are well known in the art.

This audio-visual content service provider facility 200 (and in particular the processor 201) are further configured and arranged to couple to one or more Internet media content sources 206 via the Internet 207. As used herein, the expression “Internet” will be understood to refer to the worldwide, publicly accessible series of interconnected computer networks that transmit data by packet switching using the standard Internet Protocol (IP) including, today, both IPv4 (as specified at RFC-791) and IPv6 as specified by the Internet Engineering Taskforce (IETF). So configured, the Internet media content source(s) 206 can effect the above described pre-registration activity and/or can provide the Internet-based media content to the audio-visual content service provider in support of these teachings.

Similarly, the end users 204 can also interface with the audio-visual content service provider processor via the Internet 207 (using an end user interface, for example, that supports a browser experience) to thereby make the above-described selection of Internet media content channels.

So configured, the aforementioned processor 201 can be configured and arranged, via, for example, corresponding programming as will be well understood by those skilled in the art, to carry out one or more of the aforementioned steps, actions, and functions. This can comprise, for example, receiving the aforementioned end user selection of one or more particular Internet media content channels via the audio-visual content service provider-end user interface and providing the aforementioned on-demand access to the at least one particular Internet media content channel to the end user as a selectable viewing channel along with other televised audio-visual content channels.

Those skilled in the art will recognize and understand that such a facility 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

To further demonstrate the capabilities and effectiveness of these teachings, a more detailed description of a given illustrative instantiation will now be provided. Those skilled in the art will recognize and understand that the specifics of this example serve an illustrative purpose only and are not offered with any suggestion or intent that these specifics comprise an exhaustive listing of all such possibilities in this regard.

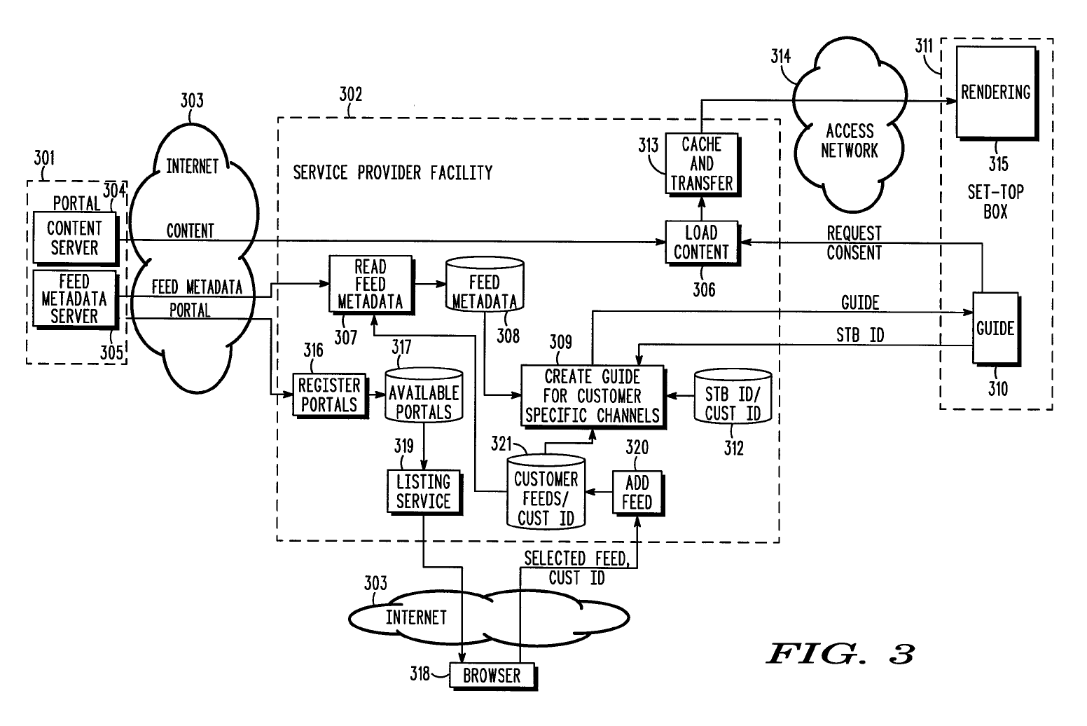

In this example, and referring now to FIG. 3, Internet media content and metadata publication occurs via the facilities of an Internet portal 301. Content loading and metadata consumption occurs via the facilities (described below) of an audio-visual content service provider's service provider facility 302. The content and metadata makes its way from the former to the latter via the Internet 303.

The Internet portal 301 can generally comprise a content server 304 and a feed metadata server 305. The content server 304 can comprise, for example, a storage facility (or access to a storage facility) having the Internet-sourced audio-visual content of interest and a processing capability to effect the transmission of the audio-visual content via the Internet 303 to the service provider facility 302. The feed metadata server 305, in turn, provides metadata comprising information (using, for example, eXtensible Markup Language (XML)) about these audio-visual contents. This information can comprise such data as the total duration of the content during playback, information regarding clip titles, information regarding clip content, information regarding persons viewable in the clip, information regarding popularity ratings, and so forth.

The service provider facility 302, in turn, includes storage facilities 306 to facilitate receiving and storing the content as sourced by the content server 304 and as delivered via the Internet 303. The feed metadata from the feed metadata server 305, in turn, is received by a read feed metadata capability 307 which parses and otherwise extracts useful content from the received feed metadata and provides the interpreted results to a feed metadata store 308. By one approach, this feed metadata need only be stored once for each portal/feed, thereby allowing these processes to re-use such information for many different end users and thereby avoiding a need to return to the portal in this regard for each end user. This stored feed metadata is then accessed by a guide creation capability 309.

This guide creation capability 309, in turn, serves to provide an electronic viewing guide 310 that is accessible to end users via their so-called set-top boxes 311. (As used herein, a set-top box will be understood to comprise a device that connects to a television and an external source of signal and converts the signal into content which is then displayed on the television display screen.)

By one approach, these guides 310 can be highly customized. For example, by one approach, the guide creation capability 309 can refer to stored information regarding an end user's identifying information and their corresponding set-top box identifier (as recovered, for example, from a corresponding memory 312 and which may comprise, for example, a Media Access Control (MAC) address as is known in the art) to provide information to a given end user regarding only their own selected Internet media content channels (along with their usual television broadcasting channels) and not all possible Internet media content channels as may be available, in the aggregate, to all end users.

So configured, the service provider facility 302 has access to Internet media content from corresponding portals 301 and can provide that content to given end users as selectable on-demand Internet media content channels. This can comprise, as shown, moving the corresponding Internet media content from the content store 306 to a cache and transfer capability which then transfers the Internet media content via the audio-visual content service provider's access network 314 and a corresponding assigned channel for rendering 315 via the end user's set-top box 311. These actions, in turn, can be taken in response to receiving a specific request from the end user via the set-top box 311 (which request can itself be based upon information contained in the aforementioned guide 310).

The illustrated architecture will also support the above-described pre-registration process. In particular, the Internet portal 301 can become registered with the service provider facility 302 via a pre-registration capability 316. The registered status of the Internet portal 301 can then be stored in a corresponding memory 317. By one approach, this registration can comprise a Uniform Resource Locator (URL) to a list of feeds that the portal supports.

Similarly, the illustrated architecture will also support the above-described Internet media content channel selection process. In particular, an end user can be informed (via a browser 318 of choice) through the Internet of a listing 319 of candidate available Internet media content channels. Using this information, the end user can then select one or more particular Internet media content channels. An add feed capability 320 can accept these selections and associate the identified channels with the end user themselves in a corresponding memory 321. The latter can then be accessed by the aforementioned guide creation capability 309 to ensure that the guide 310 provided to the end user correctly and timely reflects their Internet media content channel selections.

Those skilled in the art will recognize and appreciate that these teachings provide a simple yet powerful mechanism by which an entity having a proprietary interest in an item of audio-visual content can comfortably (both technologically and legally) provide that content to a content distributor such as a cable television service provider in a way that permits the latter to make use of that content in a way that is supplemental to an ordinary broadcast of that content and yet as customized and conditional as desired by the former. These teachings are readily scalable and will accommodate handling essentially any volume of content over essentially any practical time frame. These teachings are also highly scalable with respect to offering an ability to accommodate a virtually unlimited number of unique and differentiated content provider-based/sourced conditions regarding such usage.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an audio-visual content service provider processor:
receiving end user selection of at least one particular Internet media content channel via an audio-visual content service provider-end user interface;
providing on-demand access to the at least one particular Internet media content channel to the end user as a selectable viewing channel along with other televised audio-visual content channels.

2. The method of claim 1 wherein the audio-visual content service provider comprises a Community Access Television (CATV) service provider.

3. The method of claim 1 wherein the audio-visual content service provider-end user interface comprises a browser-based end user interface.

4. The method of claim 1 wherein the at least one particular Internet media content channel comprises a channel that provides access to a particular genre of streaming audio-visual content.

5. The method of claim 4 wherein the genre comprises at least one of:
most popular video clips;
a sports-based genre;
a comedy-based genre;
a celebrity-based genre;
a news-based genre.

6. The method of claim 1 wherein receiving end user selection of at least one particular Internet media content channel comprises receiving selections from each of a plurality of end users of at least one corresponding particular Internet media content channel from amongst a plurality of candidate Internet media content channels.

7. The method of claim 6 further comprising:
pre-registering Internet media content sources with the audio-visual content service provider to thereby form the plurality of candidate Internet media content channels.

8. The method of claim 1 wherein providing on-demand access to the at least one particular Internet media content channel to the end user as a selectable viewing channel along with other televised audio-visual content channels comprises locally storing media content from at least one particular Internet media content source at the audio-visual content service provider to thereby provide stored content and then recalling the stored content to provide the on-demand access to the end user.

9. The method of claim 1 wherein providing on-demand access to the at least one particular Internet media content channel to the end user as a selectable viewing channel along with other televised audio-visual content channels comprises combining media content from a particular Internet media content source with supplemental content when providing on-demand access to the particular Internet media content channel.

10. An apparatus comprising:
an audio-visual content service provider processor that is configured and arranged to:
receive end user selection of at least one particular Internet media content channel via an audio-visual content service provider-end user interface;
provide on-demand access to the at least one particular Internet media content channel to the end user as a selectable viewing channel along with other televised audio-visual content channels.

11. The apparatus of claim 10 wherein the audio-visual content service provider comprises a Community Access Television (CATV) service provider.

12. The apparatus of claim 10 wherein the audio-visual content service provider-end user interface comprises a browser-based end user interface.

13. The apparatus of claim 10 wherein the at least one particular Internet media content channel comprises a channel that provides access to a particular genre of streaming audio-visual content.

14. The apparatus of claim 13 wherein the genre comprises at least one of:
most popular video clips;
a sports-based genre;
a comedy-based genre;
a celebrity-based genre;
a news-based genre.

15. The apparatus of claim 10 wherein the audio-visual content service provider processor is further configured and arranged to receive end user selection of at least one particular Internet media content channel by receiving selections from each of a plurality of end users of at least one corresponding particular Internet media content channel from amongst a plurality of candidate Internet media content channels.

16. The apparatus of claim 15 wherein the audio-visual content service provider processor is further configured and arranged to pre-register Internet media content sources with the audio-visual content service provider to thereby form the plurality of candidate Internet media content channels.

17. The apparatus of claim 10 wherein the audio-visual content service provider processor is further configured and arranged to provide on-demand access to the at least one particular Internet media content channel to the end user as a selectable viewing channel along with other televised audio-visual content channels by locally storing media content from at least one particular Internet media content source at the audio-visual content service provider to thereby provide stored content and then recalling the stored content to provide the on-demand access to the end user.

18. The apparatus of claim 10 wherein the audio-visual content service provider processor is further configured and arranged to provide on-demand access to the at least one particular Internet media content channel to the end user as a selectable viewing channel along with other televised audio-visual content channels by combining media content from a particular Internet media content source with supplemental content when providing on-demand access to the particular Internet media content channel.
